(19) United States
(12) Patent Application Publication
(10) Pub. No.: US 2022/0341627 A1
(43) Pub. Date: Oct. 27, 2022

(54) HEAT GUN, AND HEATING ELEMENTS FOR A HEAT GUN

(71) Applicant: Steinel GmbH, Herzebrock-Clarholz (DE)

(72) Inventors: Heinrich Hagemeier, Warendorf (DE); Frank Albri, Herzebrock-Clarholz (DE)

(73) Assignee: Steinel GmbH, Herzebrock-Clarholz (DE)

(21) Appl. No.: 17/763,852

(22) PCT Filed: Sep. 18, 2020
(86) PCT No.: PCT/EP2020/076141

§ 371 Date: Mar. 25, 2022

(30) Foreign Application Priority Data
Sep. 27, 2019 (DE) 10 2019 126 217.8

(51) Int. Cl. F24H 3/04; F24H 9/06; F24H 9/1863; H05B 3/56; H05B 3/16

(52) U.S. Cl. CPC F24H 3/0423; F24H 9/06; F24H 9/1863; H05B 3/565; H05B 3/16; H05B 2203/03; H05B 2203/022

(57) ABSTRACT

A heating element (18) for a heating element carrier (10) of an electrically operated heat gun (100). The heating element carrier (10) is designed to receive the heating elements (18). The heating elements comprise a resistance wire (34) with a cross-sectional surface A and a cross-sectional perimeter U, where (4πA)U2<1.

### BACKGROUND OF THE INVENTION

The invention relates to a heat gun, in particular, a battery-operated hand-held hot air device, as well as a heating element carrier for a heat gun.

A hot-air fan, also called heat gun, is an electric tool with which a work space (work piece) can be purposefully heated. For this purpose, ambient air is sucked in by means of a fan device such as a fan propeller, heated by means of a heating device and then blown out to the work space through an outlet tube. By way of example only, the following common areas of use for heat guns are mentioned: removing adhesive foils, heat-sealing plastics, deforming plastics, removing layers of varnish or paint, especially on wood or metal, disinfecting lab equipment, drying objects.

Due to the continuous development of the battery technology, in particular, in the field of lithium-ion batteries, it is possible for the first time to also provide devices which, on the date of filing of this application, were exclusively supplied with energy via a cable-based external power supply, as battery-operated hand-held devices. Since a customary supply output in the range of 2000 watts available for cable-operated heat guns is not possible for battery-operated hand-held guns which operate on powers in the range of 300 watts, an efficient conversion of electric energy into heat gun output is of essential significance for the operation of a battery-operated heat gun.

Heat guns are known from the prior art in which electric heating elements, such as heating coils, are inserted or threaded into hot air ducts running through a heating element carrier so that the air flow generated by the heat gun and flowing through the hot air ducts is heated by contact with the heating elements. In order for this process to be efficient, the heating element carrier, the hot air ducts and the heating elements must be such that the heat transfer between the heating elements and the air flow, as well as the volume available for the air flow are as optimal as possible.

Accordingly, the invention is based on the object of providing a heat gun, in particular, a battery-operated hand-held heat gun, as well as a heating element carrier for a heat gun, in which the heat transfer between the heating elements and the air flow generated by the heat gun is as optimal as possible.

### SUMMARY OF THE INVENTION

This object is achieved by the heating element carrier disclosed herein, as well as by the heat gun as disclosed herein. Advantageous embodiments and further developments of the invention are also disclosed herein and stated in the sub-claims.

In accordance with the invention, heating elements for a heating element carrier of an electrically operated heat gun are provided, wherein the heating element carrier is configured to accommodate the heating elements, and the heating elements comprise a heating wire with the cross-sectional area A and the cross-sectional perimeter U, where (4πA)/U²<1 applies.

The electric heating elements can comprise a heating coil. The heating elements can comprise a flat wire. The heating coil can comprise a flat wire. The flat wire, on its flat side, can be spirally or helically wound around an imaginary cylindrical surface area extended in the longitudinal direction. In this way, a preferably large surface area of the heating coil is achieved while at the same time the cross section is as small as possible, so that at the same time the area of contact between the heating coil and the air flowing past, as well as the volume available for the air flow are increased.

In accordance with the invention, a heating element carrier is further provided for an electrically operated heat gun, with the heating element carrier having a lateral surface area extended in a longitudinal direction and two end faces perpendicular to the longitudinal direction. In this process, the lateral surface area of the heating element carrier has grooves extending in the longitudinal direction from one end face to the other end face, which has grooves configured to accommodate the electric heating elements according to the invention for the heat gun. Due to this design, the heating elements according to the invention can be inserted longitudinally into the grooves and do not need to be threaded. Furthermore, the air flowing along the grooves can freely flow around the heating elements at the side of the groove openings located on the lateral surface area, thereby increasing the area of contact between the heating elements and the air flowing past, as well as the total volume flow of the air flowing along the grooves.

Thus, in accordance with the invention, a heating element carrier, for example, a ceramic part or a ceramic disk for a battery-powered heat gun, is further provided, in which the hot air ducts are not formed closed as holes through the ceramic part, but run as circumferential grooves in the longitudinal direction within the ceramic part. Due to this design, the heating elements such as heating coils can be inserted longitudinally into the circumferential elongated grooves in the ceramic part and need not be threaded in, as is the case with hot air ducts configured as bores.

The heating elements can be held spaced apart from the bottom of the grooves by a spacer. The heating element carrier can be configured such that an area of contact between the heating elements and the heating element carrier is less than 20% of the surface area of the grooves. As a result, less heat is emitted by the heating elements to the heating element carrier, and a higher proportion of the surface area of the heating elements is brought into contact with the air flowing past.

The heating element carrier can be a ceramic body. Thus, a special heat resistance with optimum thermal properties is achieved at the same time.

The lateral surface area of the heating element carrier can have a cylindrical shape. A cross section of the heating element carrier perpendicular to the longitudinal direction can have a star-shaped configuration. Thus, the available volume of the heating element carrier is optimally used for accommodating the heating elements.

The grooves can have a W-shaped cross section so that the bottom area of the grooves has a triangular raised portion. This keeps the heating elements spaced apart from the bottom of the grooves and minimizes the area of contact between the heating elements and the heating element carrier, so that less heat is emitted by the heating elements to the heating element carrier and a higher proportion of the surface area of the heating elements is in contact with the air flowing past.

Furthermore, in accordance with the invention, a heat gun comprising a heating element carrier according to the invention and a heating element is provided.

The heat gun can comprise means of energy storage which are configured to store electric energy and supply the heat gun with electric energy. The means of energy storage may be electric accumulators. This significantly simplifies the use of the heat gun and eliminates the need for a cable-based external power supply.

The heat gun can be a hand-held device, in particular, a hot air gun with electric accumulators attachable to the bottom end of a handle area of the hot air gun, or a hot air wand.

The heat gun can have a maximum output of 600 to 1200 watts.

The heat gun can be configured to generate an air flow which flows through the heating element carrier, with the air flow flowing around the heating elements accommodated within the heating element carrier.

The heating elements can be accommodated within the heating element carrier such that the ends of the heating elements can be electrically contacted at a same end face of the heating element carrier. Thus, the assembly and contacting of the heating elements in the heat gun are simplified and less material is consumed for electric leads.

### BRIEF DESCRIPTION OF THE DRAWINGS

The invention is explained in more detail in the following text, for example, based on the drawings in which:

FIG. 1 shows a schematic view of a heat gun according to an exemplary embodiment of the invention,

FIG. 2 shows a schematic perspective view of the heating element carrier,

FIG. 3 shows a front view of the heating element carrier of FIG. 2,

FIG. 4 shows a schematic top view of the heating element carrier with inserted heating elements according to an exemplary embodiment of the invention,

FIG. 5 shows a schematic perspective view of the heating coil,

FIG. 6 shows a schematic perspective view of the flat wire.

In the various figures of the drawings, components corresponding to one another are provided with the same reference numerals.

### DETAILED DESCRIPTION

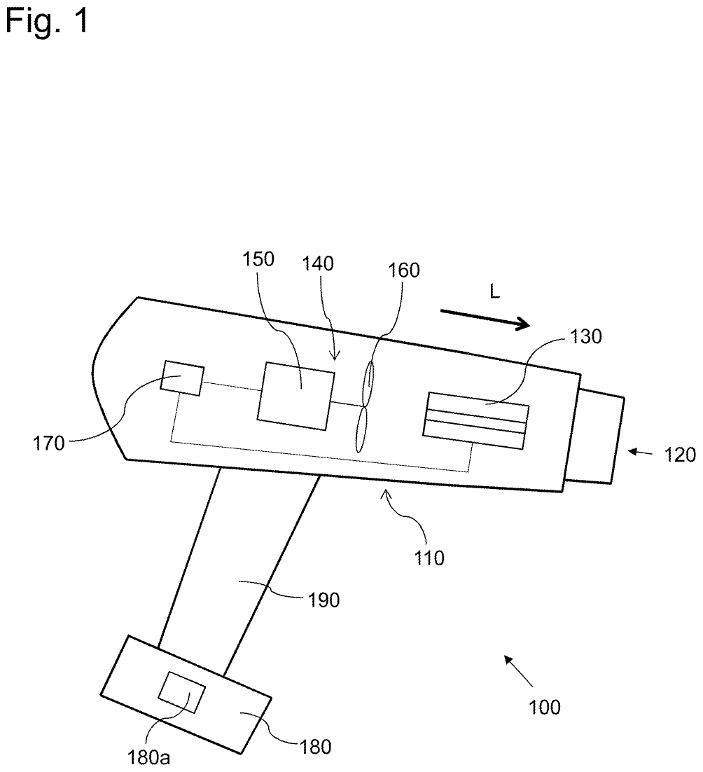

FIG. 1 shows a schematic and simplified view of a heat gun according to an exemplary embodiment of the invention.

The hot-air fan 100 illustrated in FIG. 1 has an elongated housing 110 on which, on one end, an air outlet 120 for heated air is provided. This heated air is generated by a heating device 130, through which air is sucked in through an air inlet (not shown) by means of a fan device 140 and, heated to an operating temperature of up to ca. 700° C., can exit through the air outlet 120. In this process, the operating temperature is between 300 and 500° C.

To generate the air flow, the fan device 140 has an electric motor 150 and at least one fan propeller 160 capable of being driven by means of the electric motor 150. The electric motor 150 of the fan device 140 is designed as a brush motor.

A schematically shown control unit 170 effects both a temperature control and a suitable control of the heating device 130 or of the fan device 140. The control unit 170 is electrically connected to the fan device 140 and to the heating device 130.

The electric energy supply of the heat gun 100 is effected via a battery module 180, which can be mounted or clicked into place on the bottom side of a gun-shaped handle section 190 of the heat gun 100 in the usual manner. The battery module 180 has electric means of energy storage 180a, which are preferably configured as electric batteries 180a.

In this process, a lithium-ion battery can be provided as the electric battery 180a, which can be set to an operating voltage of 18 volts. By providing the battery module 180 as the power supply, a heat gun output of the heat gun 100 according to the invention can be provided in the range of, for example, 550 watts.

Thus, the heat gun 100 has a cable-free power supply according to the exemplary embodiment shown in FIG. 1. The cable-free heat gun 100 can be designed as a battery-operated hand-held device. However, the invention is not to be restricted to the operation of a battery-operated heat gun, but can be used everywhere where optimum heat transfer between the heating elements and the air flow is convenient.

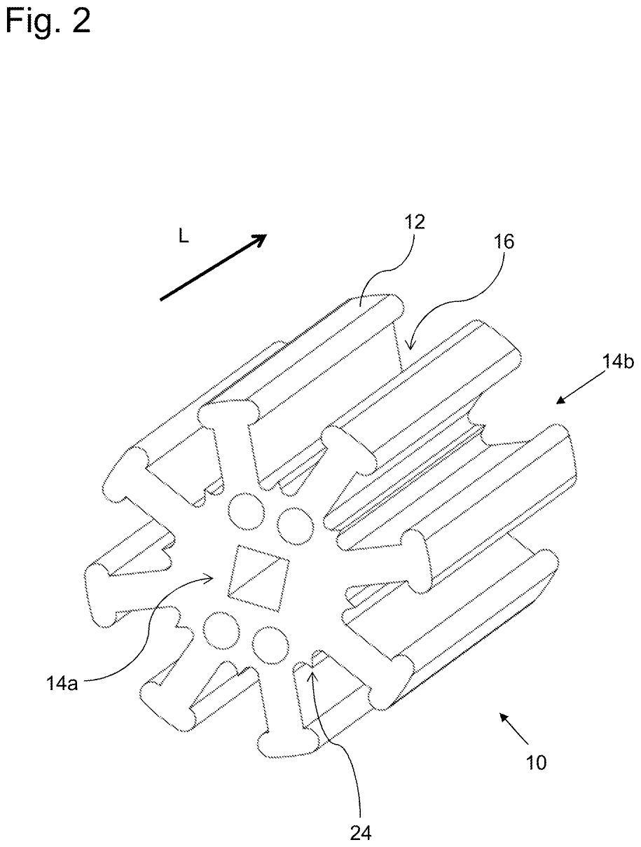

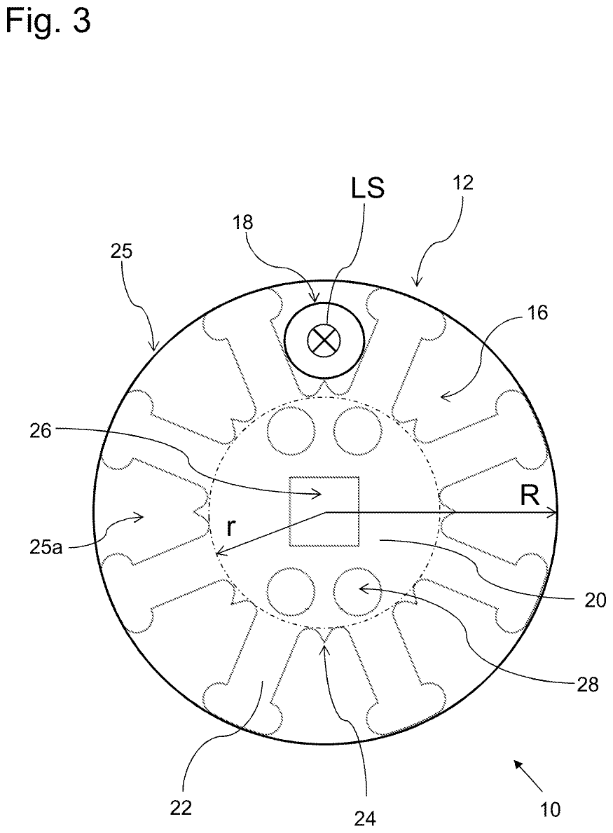

The heating device 130 is configured to generate a constant heating output in a range between 300 watts and 1200 watts, preferably in ranges between 400 watts and 600 watts or between 800 watts and 1000 watts, and, in particular, in ranges between 500 watts and 600 watts or between 900 watts and 1000 watts. The heating device 130 has at least one heating element carrier 10, which is shown in FIG. 2 in a schematic perspective view. FIG. 3 shows a front view of the heating element carrier of FIG. 2.

As can be seen from FIG. 2 and FIG. 3, heating element carrier 10 has a lateral surface area 12 extended in a longitudinal direction (L) and two end faces 14a, 14b perpendicular to the longitudinal direction. The lateral surface area 12 of the heating element carrier 10 has a plurality of grooves 16 extending from one end face to the other end face in the longitudinal direction (L), which are configured to accommodate electric heating elements 18 for the heat gun 100. The lateral surface area 12 of the heating element carrier, for example, can have a cylindrical shape. The heating element carrier can be a ceramic body.

As can be seen from FIG. 3, the grooves 16 are configured such that the cross section of the heating element carrier 10 perpendicular to the longitudinal direction has a star-shaped configuration. In this process, the cross section of the heating element carrier 10 has a circular inner section 20 with an inner radius r, as well as a plurality of T-shaped protrusions 22 protruding outward radially from the inner section 20, with the T-shaped protrusions 22 extending to an outer radius R. Between the T-shaped protrusions are smaller triangular or lace-like protrusions 24 or raised portions 24 protruding outward radially from the inner section 20. Thus, the grooves 16 are defined by the space located between two adjacent T-shaped protrusions 22 and have a W-shaped cross section so that the bottom area of the grooves 16 has a triangular raised portion 24.

The heating element carrier 10 with accommodated heating elements 18 is electrically and thermally insulated from the external environment by an outer shell 25. The outer shell 25 directly borders on the lateral surface area 12 of the heating element carrier 10. For example, the outer shell 25 can be a cylinder with radius R extended in the longitudinal direction L. The outer shell 25, for example, can consist of multiple layers of mica paper (micanite). The air flow LS generated by the blower device 140 flows through the hot air ducts 25a limited by the grooves 16 and the outer shell 25 in the longitudinal direction L. In this process, the air flow LS flows around the heating elements 18.

Due to the above-described design of the hot air ducts 25a, the area immediately adjacent to the outer shell 25 between the outer ends of two T-shaped protrusions becomes accessible for the air flow LS. This increases the volume of air transported per time unit, while also increasing the area of contact between the heating elements 18 and the air flow LS at the same time. The heating elements 18 are held spaced apart from the bottom of the grooves 16 by triangular raised portions 24 serving as spacers, so that the area of contact between the heating elements 18 and the heating element carrier 10 is minimized.

The heating element carrier 10 further comprises a central bore 26 extending in the longitudinal direction L and having a square cross section, as well as one or more circular bores 28 extending in the longitudinal direction L. The bore 26 serves to secure the heating element carrier 10 inside the housing 110. The round bores serve to accommodate thermocouples (not shown), which serve for temperature measurement and are electrically connected to the control unit 170.

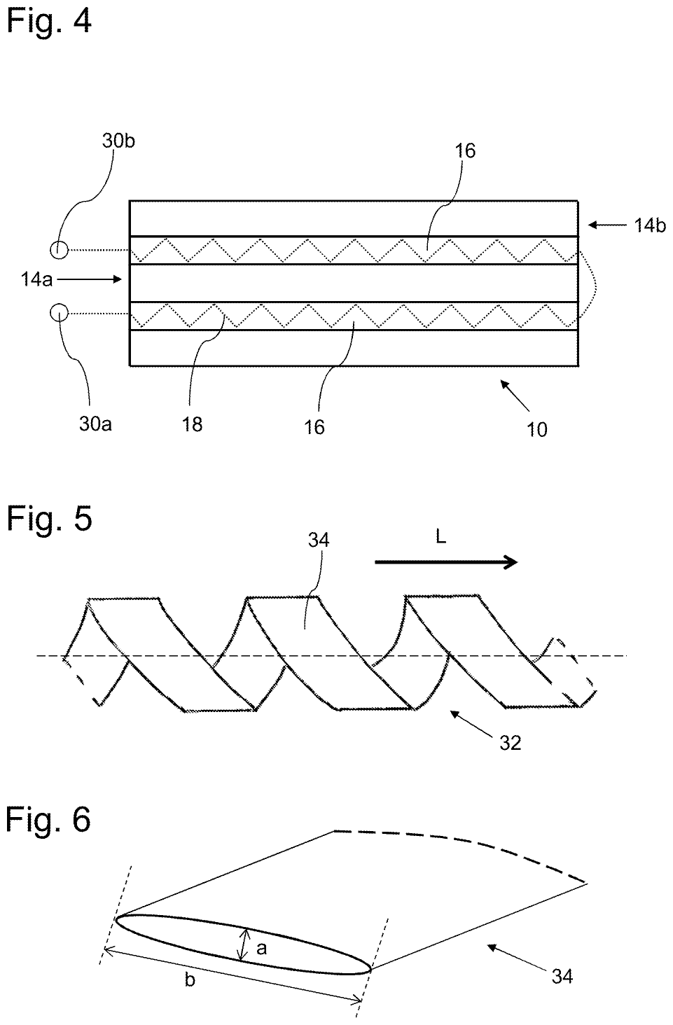

FIG. 4 shows a schematic top view of the heating element carrier 10 with the electric heating elements 18 accommodated within the grooves 16, shown purely schematically. As can be seen from FIG. 4, the electric heating elements 18 are accommodated within the grooves 16 such that the ends of the heating elements can be electrically contacted at a same end face 14a of the heating element carrier 10 by means of the contacts 30a, 30b.

The electric heating elements 18 can comprise a heating coil 32, as shown in FIG. 5 in a schematic perspective view. The heating coil 32 comprises a heating wire 34, where the heating wire 34 can be a round wire or a wire of any other cross section. The heating wire 34, for example, can be made of a nickel-chromium alloy.

In the exemplary embodiment shown in FIG. 5, the heating coil 32 comprises a flat wire 34, with the flat wire 34, on its flat side, being spirally or helically wound around an imaginary cylindrical surface area extended in the longitudinal direction (L). The design of the electric heating elements 18 in the form of a heating coil 32 made of flat wire 34 described above has several advantages.

As can be seen from FIG. 3, the area of contact between the heating elements 18 and the heating element carrier 10 is less than 20%, or less than 15%, or less than 10%, or less than 8%, or less than 5%, or less than 1%, or less than 0.5% of the surface area of the grooves 16. Due to the fact that the flat wire, on its flat side, is spirally wound around an imaginary cylindrical surface area extended in the longitudinal direction (L), both the volume located inside the imaginary cylindrical surface area and the volume located outside the imaginary cylindrical surface area are accessible for the air flow LS. At the same time, the air flow comes into contact with the flat side surface area of the flat wire both on the inside and on the outside of the imaginary cylindrical surface area. The direction of the air flow L is parallel (tangential) to the flat side surface area of the flat wire, whereby the flow resistance is additionally minimized.

The fact that grooves are provided inside the heating element carrier 10 for accommodating the heating elements 18 also results in advantages for the assembly of the heating device 130. For example, the heating coil 32 can be inserted or pressed longitudinally into the grooves from the outside and need not be threaded or pushed through, as in the case of a bore. Particularly, in the case of a design of the heating elements 18 as a heating coil 32 made of flat wire 34, threading the heating coil 32 into a bore can become very tedious if not impossible, whereas potential manufacturing tolerances can be easily bridged when the heating coil 32 is accommodated within a groove 16.

FIG. 6 shows a schematic perspective view of the flat wire 34. The flat wire 34 is characterized in that it does not have a round cross section, so that the following relationship (isoperimetric inequality) applies between its cross-sectional area A and its cross-sectional circumference U:

K=(4πA)/U²<1.

The variable K, for example, can be less than 0.8, less than 0.6, less than 0.4, less than 0.2, less than 0.1, less than 0.05, less than 0.025, or less than 0.01.

The cross section of the flat wire 34, for example, can have an elliptical shape with a semi-minor axis a and a semi-major axis b, or a rectangular shape with sides a and b. In this process, the ratio of a and b can be less than 1, less than 0.8, less than 0.6, less than 0.4, less than 0.2, less than 0.1, less than 0.05, less than 0.025, or less than 0.01. For example, a can be 1.5 mm and b=0.25 mm.

Thus, in the heating element carrier 10 for a battery-powered heat gun 100 described herein, the hot air ducts 25a are no longer formed closed as bores through the ceramic part 10, but are provided as circumferential grooves 16 in the longitudinal direction L within the ceramic part 10. This design allows the heating coils 32 to be inserted longitudinally into the circumferential longitudinal grooves 16 in the ceramic part, and no longer need to be threaded as is currently the case in the prior art. A further advantage is that the air can flow freely in this area, less surface area is obstructed, and a higher volume flow is possible.

The invention thus serves to heat gases flowing past, in particular, air. For this purpose, a gas flow flows through the device according to the invention, absorbing the thermal energy emitted by the electric heat conductor.

At present, a heat conductor with a round cross section is used in air or gas flow heating. These have always been used in recent years as they are available in large quantities and with different cross sections.

The round cross section of the heat conductor is the most efficient shape to obtain the maximum cross section with a small surface area. However, in the case of air heating, this is counterproductive. A larger surface area for the same cross section allows a gas flowing past to absorb more heat. The heat conductor can therefore be designed shorter and still emit the same heat output as a longer round heat conductor.

To build a heater that is as short as possible and therefore also as light as possible, the heat conductor surface area must be as large as possible in order to be able to heat a certain volume of gas. The flat heat conductor achieves a large surface area with a small cross section. This makes the design of the heater shorter than for comparable heaters with a round cross section.

From an economic point of view, a flat heat conductor and thus a shorter heater is advantageous, since all heating components can be shorter. The ceramic parts and the blow-out tube are shorter and thus more economical on raw materials than conventional heat conductors, while the heating time to the set air flow temperature is reduced.

1-17. (canceled)

18. A battery-operated heat gun (100), comprising:
a fan device (140) for generating an air flow (LS);
a heating device (130) for heating the air flow (LS); and
means of energy storage (180a) which are configured to store electric energy and supply the heat gun (100) with electric energy, wherein the heating device (130)
includes a heating element carrier (10), which has a lateral surface area (12) extended in a longitudinal direction (L) and two end faces (14a, 14b) perpendicular to the longitudinal direction (L), wherein the lateral surface area (12) of the heating element carrier (10) has grooves (16) which extend from one end face (14a) to the other end face (14b) in the longitudinal direction (L), and
includes heating elements (18) comprising a flat wire (34), which are accommodated longitudinally into the circumferential grooves (16) of the heating element carrier (10) such that the generated air flow (LS) flows around the heating elements (18).

19. The heat gun (100) according to claim 18, wherein the heating elements (18) comprise a heating coil (32), and wherein the flat wire (34) as heating coil (32) is, on its flat side, spirally or helically wound around an imaginary cylindrical surface area extended in the longitudinal direction (L).

20. The heat gun (100) according to claim 19, wherein the heating coil (32) is inserted or pressed longitudinally into the grooves (16) from the outside.

21. The heat gun (100) according to claim 18, wherein the flat wire (34) has a cross-sectional area A and a cross-sectional perimeter U, and wherein (4πA)/U²<1 applies.

22. The heat gun (100) according to claim 18, wherein the flat wire (34) is made of a nickel-chromium alloy.

23. The heat gun (100) according to claim 18, wherein the heating element carrier (10), in its cross section perpendicular to the longitudinal direction (L), has a circular inner section (20) and a plurality of T-shaped protrusions (22) protruding outward radially from the inner section (20), with the grooves (16) being defined by a space located between two adjacent T-shaped protrusions (22).

24. The heat gun (100) according to claim 18, wherein the area of contact between the heating elements (18) and the heating element carrier (10) is less than 20% of the surface area of the grooves (16).

25. The heat gun (100) according to claim 18, wherein the heating elements (18) are kept spaced apart from the bottom of the grooves (16) by a spacer (24).

26. The heat gun (100) according to claim 18, wherein the heating element carrier (10) is a ceramic body.

27. The heat gun (100) according to claim 18, wherein the lateral surface area (12) of the heating element carrier (10) has a cylindrical shape.

28. The heat gun (100) according to claim 18, wherein a cross section of the heating element carrier (10) perpendicular to the longitudinal direction (L) has a star-shaped configuration.

29. The heat gun (100) according to claim 18, wherein the grooves (16) have a W-shaped cross section so that the bottom area of the grooves (16) has a triangular raised portion (24).

30. The heat gun (100) according to claim 18, wherein the means of energy storage (180a) are electric accumulators (180a).

31. The heat gun (100) according to claim 18, wherein the heat gun (100) is a hand-held device (100) with electric accumulators (180a) attachable to the bottom end of a handle area (190) of the hot air gun (100), or a hot air wand.

32. The heat gun (100) according to claim 31, wherein the hand-held device (100) is a hot air gun (100).

33. The heat gun (100) according to claim 32, wherein the heat gun (100) has a maximum output of 600 to 1200 watts.
